(19) United States
(12) Patent Application Publication
(10) Pub. No.: US 2003/0231171 A1
(43) Pub. Date: Dec. 18, 2003

(54) Electronic apparatus and suspend/resume method

(75) Inventors: Hiroaki Yokomichi, Hamura-shi (JP); Toshikazu Morisawa, Tokorozawa-shi (JP); Satoshi Tamura, Ome-shi (JP)

Correspondence Address: Finnegan, Henderson, Farabow,, Garrett & Dunner, L.L.P., 1300 I Street, N. W., Washington, DC, 20005-3315, US

(73) Assignee: KABUSHIKI KAISHA TOSHIBA

(21) Appl. No.: 10/425,744

(22) Filed: Apr. 30, 2003

(30) Foreign Application Priority Data
Jun. 17, 2002 (JP) 2002-175611

(51) Int. Cl. G06F 1/26; G06F 1/28; G06F 1/30; G06F 13/00; G09G 5/00

(52) U.S. Cl. 345/204; 345/537; 713/324

(57) ABSTRACT

A BIOS saves, when a system is changed to a suspended state, contents of a VRAM included in a display controller in a VRAM save area reserved on a system memory, and then cuts off power supply to sections of the system, including the display controller, while maintaining power supply to the system memory. In the meantime, at the time of resume, the BIOS resumes the power supply to sections of the system, including the display controller, and then restores the contents saved in the VRAM save area of the system memory to the VRAM.

### CROSS-REFERENCE TO RELATED APPLICATIONS

This application is based upon and claims the benefit of priority from the prior Japanese Patent Application No. 2002-175611, filed Jun. 17, 2002, the entire contents of which are incorporated herein by reference.

### BACKGROUND OF THE INVENTION

1. Field of the Invention

The present invention relates to an electronic apparatus with a display device such as an LCD, and a suspend/resume method for the apparatus. In particular, the present invention relates to an electronic apparatus and a method of suspending/resuming the apparatus, which can further reduce power consumption at the time of suspend, without causing a long-time resume.

2. Description of the Related Art

Recently, portable electronic apparatuses, such as personal digital assistant (PDA), which can be driven by battery, have come into wide use. In these apparatuses, various power-saving mechanisms are provided, to lengthen the life of the battery, even if only slightly.

Further, electronic apparatuses of this kind generally have a suspend/resume function which stores the state of the computer at the time of turning off the power of the computer and restores the stored state, such that the last work can be instantly resumed when the computer is turned on again.

In the meantime, if an electronic apparatus is suspended by the suspend/resume function, in the conventional art, power supply to a system memory and a video memory is continued, to maintain their contents. However, in recent apparatuses, a video memory is included in a display controller, and thus it is required to continue power supply to the whole display controller to use the suspend/resume function. Thus, this method is not very preferable from the viewpoint of reducing power consumption.

In consideration of the above, a suspend/resume method disclosed in Jpn. Pat. Appln. KOKAI Pub. No. 11-259162 transmits the contents of a video memory to a hard disk drive, and then transfers the apparatus into a suspended state. According to this method, power supply to a video memory, that is, power supply to a display controller can be cut off during suspend, and unnecessary power consumption can be prevented.

However, since this method restores the contents of the video memory at the time of resume, using the hard disk drive, the resume processing requires much time.

### BRIEF SUMMARY OF THE INVENTION

An embodiments of the present invention is to provide an electronic apparatus and a suspend/resume method for the apparatus, which can further reduce power consumption at the time of suspending, without causing a long-time resuming.

According to an aspect of the invention, it provides an electronic apparatus capable of executing a suspend processing, comprising: a first memory which stores system data; a second memory which stores display data; a suspend instruction unit configured to determine whether or not to execute the suspend processing; a suspend unit configured to save the display data stored in the second memory to the first memory, when the suspend instruction unit has determined to execute the suspend processing; and a power control unit configured to stop power supply to the second memory, and maintain power supply to the first memory.

Accordingly, contents of a video memory are saved in a predetermined area in a system memory, thus power supply to a video memory or a display controller including the video memory can be cut off. Further, at the time of resume, the contents of the video memory can be restored with a very short time by using a system memory, unlike in the case of using a hard disk drive.

Additional features and advantages of the invention will be set forth in the description which follows, and in part will be obvious from the description, or may be learned by practice of the invention. The features and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing an appearance of an electronic apparatus according to an embodiment of the present invention.

FIG. 2 is a block diagram showing a part of a main structure of the electronic apparatus of the embodiment.

FIG. 3 is a flow chart showing a suspend processing of the electronic apparatus of the embodiment.

FIG. 4 is a flow chart showing a resume processing of the electronic apparatus of the embodiment.

FIG. 5 is a diagram showing a personal computer to which a method of the present invention is applicable.

### DETAILED DESCRIPTION OF THE INVENTION

An embodiment of the present invention will now be described with reference to the drawings.

FIG. 1 is a diagram showing an appearance of an electronic apparatus according to an embodiment of the present invention.

The electronic apparatus is a personal digital assistant (PDA) having a proper size such that a user can hold it by one hand. The PDA 10 is configured to be driven by a battery, and has a suspend/resume function by which the last work on the PDA can be instantly resumed when the PDA 10 is turned on again. A liquid crystal display (LCD) 16 for data display is provided on a front surface of the PDA.

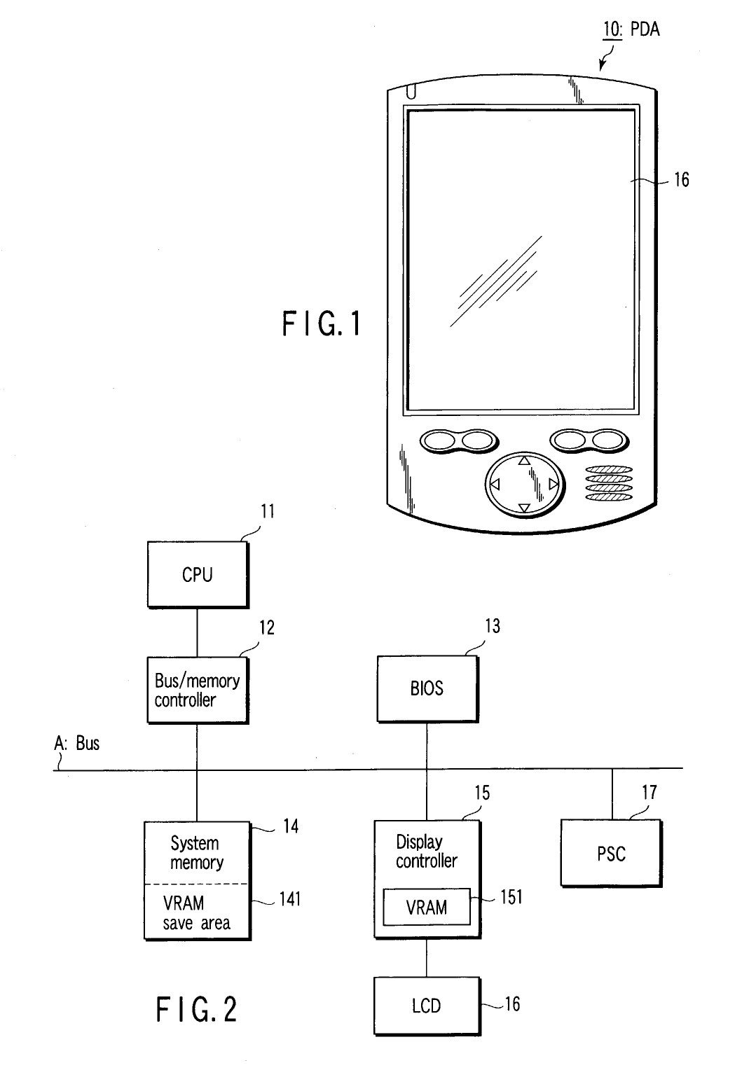

FIG. 2 is a block diagram showing a part of a main structure of the electronic apparatus of the embodiment.

As shown in FIG. 2, in the PDA 10, a bus A for transmitting and receiving data is laid. Further, with the bus A serving as a backbone, CPU 11, a bus/memory controller 12, a basic input/output system (BIOS) 13, a system memory 14, a display controller 15, the LCD 16, and power supply controller (PSC) 17 are provided.

The CPU 11 controls the whole PDA 10, and operates in accordance with description of a program stored in the system memory 14. The bus/memory controller 12 has a bridge function of bridging a CPU local bus and the bus A, and a function of a cashe for the system memory 14.

The BIOS 13 drives and controls various peripheral devices, such as a hard disk unit (not shown), of the PDA 10. The BIOS 13 realizes the above suspend/resume function.

The system memory 14 is a memory device serving as a main storage of the PDA 10, and stores a program describing an operation sequence of the CPU 11, and data inputted and outputted from the program. Although the system memory 14 is a volatile memory, power supply to the system memory 14 is continued even during suspend.

Further, in the PDA 10 of the embodiment, a VRAM save area 141 which only the BIOS 13 recognizes is reserved on the system memory 14. The area is reserved by notifying an operating system of a smaller size than the actual size of the system memory 14 (a size obtained by deducting the size of the VRAM save area 141 from the actual size of the system memory 14), when, for example, the operating system has started.

The display controller 15 includes a VRAM 151 for storing display data generated by the CPU 11, and performs control to display the display data stored in the VRAM 151 on the LCD 16.

The PSC 17 is supply power to device provided in the PDA 10. When the suspend has done, the PSC 17 supplies the power to the system memory 14, and stop supplying the power to the display controller.

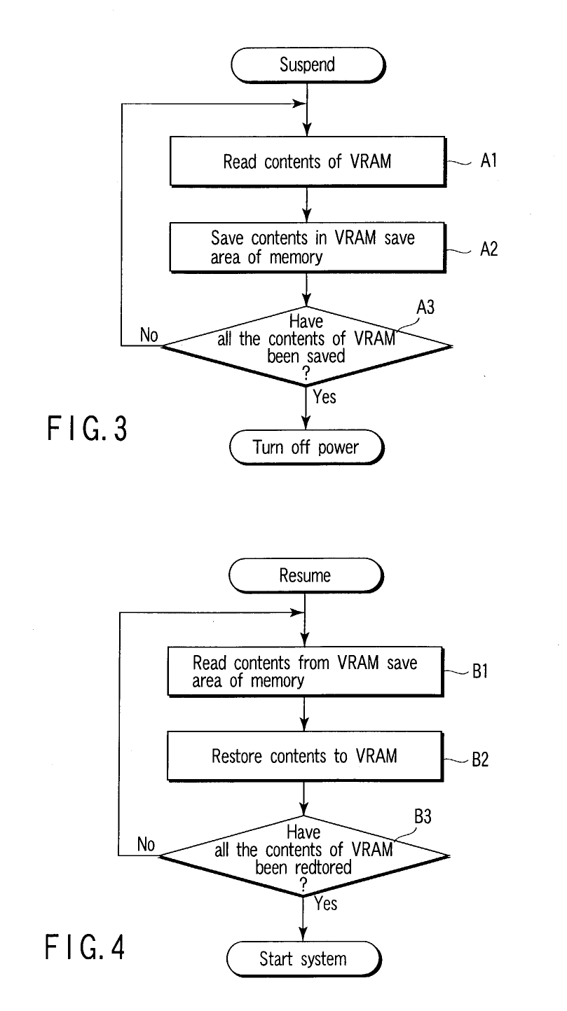

Next, with reference to FIGS. 3 and 4, the operation sequence of the PDA 10, having the above structure, at the time of suspend/resume will now be described.

FIG. 3 is a flow chart showing a suspend processing of the electronic apparatus of the embodiment.

At the time of suspend, the BIOS 13 detects the suspend instruction. Then the BIOS 13 reads the display data stored in the VRAM 151 (step A1), and saves the read display data in the VRAM save area 141 of the system memory 14 (step A2). Then, the BIOS 13 checks whether all the contents of the VRAM 151 have been saved (step A3) and, if not (NO of step A3), repeats the processing from step A1. If they have been saved (YES of step A3), the BIOS 13 turns off the power of the PDA.

Further, FIG. 4 is a flow chart showing a resume processing of the electronic apparatus of the embodiment.

At the time of resume, first the BIOS 13 reads the display data, which was saved at the time of suspend, from the VRAM save area 141 of the system memory 14 (step B1), and restores the read display data in the VRAM 151 (step B2). Then, the BIOS 13 checks whether all the contents of the VRAM 151 have been restored (step B3) and, if not (NO of step B3), repeats the processing from step B1. If they have been restored (YES of step B3), the BIOS 13 starts the system.

As described above, the PDA 10 of the embodiment saves the contents of the VRAM 151 in the VRAM save area 141 on the system memory 14 at the time of suspend, and thus power supply to the display controller 15 including the VRAM 151 can be cut off, and the power consumption during suspend can be reduced.

Further, at the time of resume, the contents of the VRAM 151 are restored by using the system memory 14, and thus the resume can be completed with a very short time.

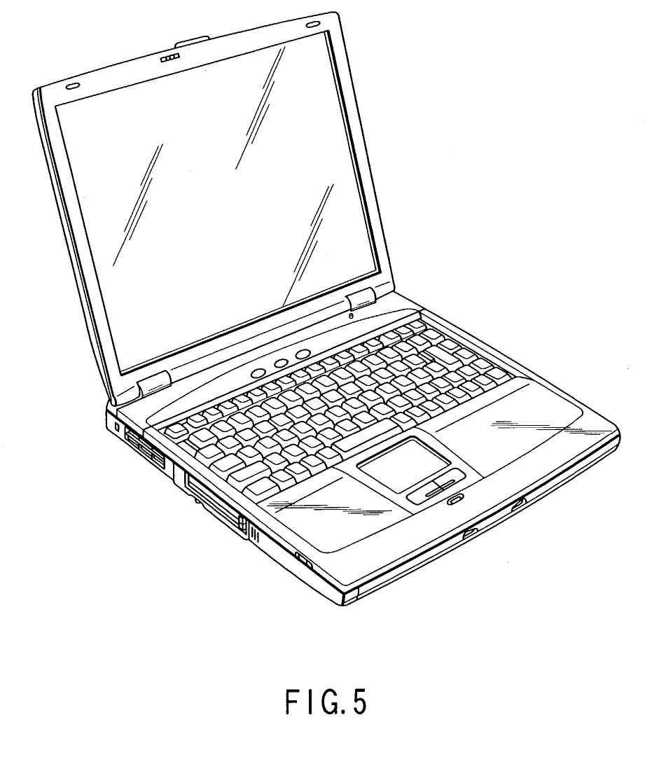

Although in the above the present invention has been explained with the PDA 10 as an example, the method of the present invention is also applicable to, for example, a personal computer as shown in FIG. 5. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus capable of executing a suspend processing, comprising:
a first memory which stores system data;
a second memory which stores display data;
a suspend instruction unit configured to determine whether or not to execute the suspend processing;
a suspend unit configured to save the display data stored in the second memory to the first memory, when the suspend instruction unit has determined to execute the suspend processing; and
a power control unit configured to stop power supply to the second memory, and maintain power supply to the first memory.

2. The electronic apparatus according to claim 1, the first memory and the second memory is a volatile memory.

3. The electronic apparatus according to claim 2, further comprising:
a resume instruction unit configured to determine whether or not to execute a resume processing which restores the data saved by the suspend unit; and
a resume unit configured to start power supply to the second memory and restore the display data stored in the first memory to the second memory, when the resume instruction unit has determined to execute the resume processing.

4. The electronic apparatus according to claim 1, the suspend unit stores the display data in a specific area reserved in the first memory.

5. The electronic apparatus according to claim 4, the specific area not being recognized by any programs other than a BIOS program of the electronic apparatus.

6. The electronic apparatus according to claim 1, further comprising a display controller which processes the display data,
the second memory being provided in the display controller.

7. An electronic apparatus capable of executing a suspend processing, comprising:
a first memory which stores system data;
a second memory provided in a display control unit of the electronic apparatus;
a suspend instruction unit configured to determine whether or not to execute the suspend processing;
a suspend unit configured to save data stored in the second memory to the first memory, when the suspend instruction unit has determined to execute the suspend processing; and
a power control unit configured to stop power supply to the display control unit, and maintain power supply to the first memory.

8. The electronic apparatus according to claim 7, further comprising:
a resume instruction unit configured to determine whether or not to execute a resume processing which restores the data saved by the suspend unit; and
a resume unit configured to start power supply to the device and restore the data stored in the first memory to the second memory, when the resume instruction unit has determined to execute the resume processing.

9. An electronic apparatus capable of executing a suspend processing, comprising:
a first memory which stores system data;
a second memory which stores display data;
a control unit configured to detect an instruction to execute the suspend processing, and save the display data stored in the second memory to the first memory; and
a power supply unit configured to supply power to the first memory and stop supplying power to the second memory during the suspend processing has executed.

10. A suspend method for an electronic apparatus having a first memory which stores system data and a second memory which stores display data, comprising:
saving the display data stored in the second memory to the first memory, when an instruction to execute a suspend processing is received;
stopping power supply to the second memory after the saving; and
maintaining power supply to the first memory.

11. The suspend method according to claim 10, wherein a predetermined area to store the display data of the second memory is reserved in the first memory, and the display data is stored in the predetermined area at the time of executing the suspend processing.

12. A suspend/resume method for an electronic apparatus having a first memory which stores system data and a second memory which stores display data, comprising:
saving the display data stored in a second memory to the first memory, when an instruction to execute a suspend processing is received;
stopping power supply to the second memory after the saving;
maintaining power supply to the first memory, starting power supply to the second memory, when an instruction to execute a resume processing is received; and
restoring the display data stored in the first memory to the second memory.

13. The suspend/resume method according to claim 12, the second memory being provided in a display controller of the electronic apparatus,
power supply to the second memory being stopped in response to stop of power supply to the display controller in the suspend processing, and
power supply to the second memory being started in response to power supply to the display controller in the resume processing.

14. The suspend/resume method according to claim 12, wherein a predetermined area to store the display data of the second memory is reserved in the first memory, and the display data is stored in the predetermined area at the time of executing the suspend processing.

15. The suspend/resume method according to claim 14, the second memory being provided in a display controller of the electronic apparatus, power supply to the second memory being stopped in response to stop of power supply to the display controller in the suspend processing, and power supply to the second memory being started in response to power supply to the display controller in the resume processing.
